(19) United States
(12) Patent Application Publication
(10) Pub. No.: US 2003/0021182 A1
(43) Pub. Date: Jan. 30, 2003

(54) Mixer for mixing a secondary gas into a primary gas

(76) Inventors: Fabien S. Illy, Paris (FR); Pierre Avrillier, Paris (FR)

Correspondence Address: BURNS, DOANE, SWECKER & MATHIS, L.L.P., P.O. Box 1404, Alexandria, VA, 22313-1404, US

(21) Appl. No.: 10/253,435

(22) Filed: Sep. 25, 2002

Related U.S. Application Data
(62) Division of application No. 09/759,266, filed on Jan. 16, 2001.

(30) Foreign Application Priority Data
Jan. 25, 2000 (FR) 00 00945

(51) Int. Cl. B01F 3/02; B01F 5/04

(52) U.S. Cl. 366/165.5; 366/173.2; 366/182.4; 137/3

(57) ABSTRACT

The invention relates to a mixer for mixing an industrial secondary gas (B) into an industrial primary gas (A).

The mixer comprises:

a pipe (10) for supplying the primary gas;

N (N≧2) secondary-gas injectors (12), the openings of which run into the said pipe in the mixing zone, the said openings of the injectors being placed in the same cross section of the pipe, all the injectors having the same optimum flow rate range;

valve-based means (14) for controlling the secondary-gas flow rate in the said injectors; and

control means (20) for controlling the said valve-based means (14) so that each injector is fed with gas at a zero flow rate or at a flow rate common to all the injectors fed, the said common flow rate lying within the optimum flow rate range.

The subject of the present invention is a mixer and a method for mixing an industrial gas into a primary gas.

More specifically, the invention relates to a mixer and to a method which allow a mixture of a secondary gas, especially an industrial secondary gas, to be mixed into a primary gas, especially an industrial primary gas, in suitable proportions and very homogeneously.

In the present invention, the term “secondary gas” or “primary gas” should be understood to mean not only a pure gas but also a premixture of gases, for example air. In addition, in the examples cited, the flow rates indicated should be understood to mean under standard temperature and pressure conditions.

Mixing operations are usually carried out by static mixers which, by means of a feature, create a pressure drop which causes the mixing. These mixers are very efficient but also very bulky. They cannot easily be fitted into already existing plants, as is the case with de-bottlenecking devices. In addition, they may carry a risk of blockage and of particle trapping. The presence of catalyst particles on the metal support of static mixers has already caused accidents and explosions, for example in the manufacture of nitric acid.

When the size of the mixer has to be limited without wishing to correspondingly sacrifice the mixing efficiency, jet-type mixers are used. This technique is especially described in European Patent Application 0 474 524. The above technique is used for superoxygenation operations in FCC plants and catalytic oxidations or oxidations in furnaces (in metallurgy or in the glass or cement industries). This very effective method is limited in the amounts of gas that it is possible to mix and in its flexibility. This is because the ratio of the injected-gas flow rate or secondary flow rate to the primary flow rate is generally limited to 10 to 15%. It is impossible to provide optimum mixing conditions outside a variation of ±20% around the nominal injected-gas flow rate corresponding to the definition of the mixer for a constant primary gas flow rate. Designed as a de-bottlenecking tool, it is perfectly well suited to continuous operations but it proves to be unsuitable when the final injected-gas flow rate is high. For example, the same mixer cannot mix efficiently from 200 to 1200 m³/h, i.e. an injected-gas flow rate that can vary from 1 to 6, as may be desirable in the case of oxygen-doped units, and the installation of several successive injectors becomes expensive and difficult to implement. Step changes, if they persist, must be accompanied by injector changes.

Based on a similar jet principle, but with coaxial jets, many so-called “rake”-type mixers exist for injecting a fuel gas into air or an oxidizer in order to limit the risk of ignition (or vice versa). These injectors are based on the principle of many small jets coaxial with the primary stream. By limiting the gas volume, the potentially inflammable volume is limited and the relatively high injection velocity of the oxidizer (or fuel) ensures in principle neither flame attachment nor flame return into the injector.

This type of injector is found in the process for synthesizing ethylene oxide (oxygen injection) or for synthesizing maleic anhydride (butane injection) among others. These mixers are somewhat inflexible and bulky (with a large long bundle of small tubes) and do not use the turbulent nature of cross-flow jet mixers. Since the jets are coaxial, the mixing is predominantly diffusional, thereby. downgrading the performance of mixtures.

Certain apparatuses also include a means of controlling the injected-gas velocity in order to allow its safety characteristics to be maintained even in a varying or non-steady state. The degree of opening of the orifices at the point of injection cannot easily be modified and requires a great deal of attention with regard to the closure mechanism which has to work in a sometimes difficult atmosphere (oxygen, reactive gases) in which it is better to limit the hot spots due to repeated friction or to mechanical wear.

Certain other apparatuses also include means for keeping the content of one of the components of a mixture constant.

Yet other apparatuses include means for ensuring that one of the constituents, which will be present downstream of the mixer, for example a product or the excess of a reactant leaving a reactor mounted downstream of the mixer, is kept constant.

One object of the present invention is to provide a gas-mixing method and a gas mixer which combine the flexibility and performance advantages of static mixers with the compactness and safety and performance characteristics of cross-flow jet mixers.

To achieve this objective, according to the invention, the method for mixing a secondary gas into a primary gas comprises the following steps:

a primary stream of the said primary gas is formed;

the total flow rate of secondary gas to be injected is regulated according to a setpoint value;

the secondary gas is injected with the said total flow rate into an injection zone of the said primary steam, the said injection zone extending in the direction of the axis of the said primary stream, by means of a plurality of injectors placed in the said injection zone so as to form a plurality of secondary-gas jets, each injector having an optimum flow rate range; and

the said secondary gas is distributed between at least some of the said injectors in such a way that each injector fed operates within its optimum flow rate range.

It will be understood that, by virtue of the arrangements of the invention, mixing homogeneity is ensured because of the multiplicity of injectors and because these injectors are controlled so as to operate within their optimum flow rate range. It will also be understood that, because of the multiplicity of these injectors, the secondary gas can be controlled so as to flow at a rate lying within a wide range without degrading the quality of the mixing.

The expression “optimum flow rate range” should be understood to mean all the flow rates for which the secondary-gas jet will be optimally mixed into a given primary gas flow. This range may be expressed by a range of characteristic ratios based on volume kinetic energy.

It should be noted that these dynamic conditions depend on the nature of the gases (density, molar mass, viscosity, etc.), on the operating and/or delivery pressure and temperature.

According to a preferred embodiment of the method, in order to be able to mix into the primary gas a secondary gas with a flow rate D of between 2d₁, d₁ being the minimum value of the optimum flow rate range of the injectors, and Nd₂, d₂ being the maximum value of the optimum flow rate range of the injectors, the maximum number N1 of injectors to be fed is determined in the following manner:

the flow rate D is divided, into a set of integers by d₁, which gives an integer quotient k and a remainder r;

the quotient k is compared with the number N of injectors and

if k≧N, then N1=N or

if k<N, then N1=k

and in that the flow rate of each of the N1 injectors is equal to D/N1.

It will be understood that by implementing this method, that is to say this programme of controlling the flow rate of each injector, it is possible to mix a secondary gas under optimum conditions with a flow rate lying within a very wide range and varying continuously within this range.

Another object of the invention is to provide a mixer which comprises:

a pipe (10) for supplying the primary gas, the said pipe having an injection zone;

N (N≧2) secondary-gas injectors (12), the openings of which run into the injection zone of the said pipe, each injector having an optimum flow rate range; and

means for distributing the total secondary-gas flow rate between at least some of the said injectors so that each injector is fed with gas at a zero flow rate or at a flow rate lying within the optimum flow rate range of the said injector.

According to a first embodiment, the axis of at least some of the injectors makes, in the cross section of the pipe which contains the openings of the injectors, an angle a lying between 10 and 70 degrees, preferably between 25 and 45 degrees, with respect to the normal to the wall of the pipe.

It will be understood that, by virtue of this arrangement, on the one hand the tangential component of each secondary-gas jet induces a swirling motion which encourages mixing and on the other hand the angulation of the jets prevents the latter from mutually coalescing at the centre of the line.

According to another embodiment, the mixer is equipped with an obstacle which is placed in the mixing zone of the pipe, along the longitudinal axis of the latter, and even more preferably the obstacle is connected to the pipe itself by fastening means which are suitable for creating a disturbance in the flow of primary gas.

In this case, it is not necessary for the jets produced by the injectors to be angled with respect to the normal to the wall of the pipe since, because of the presence of the obstacle, the problems of coalescence do not arise.

Further characteristics and advantages of the invention will become clearer on reading the description which follows of several embodiments of the invention, these being given by way of non-limiting examples. The description refers to the appended figures in which:

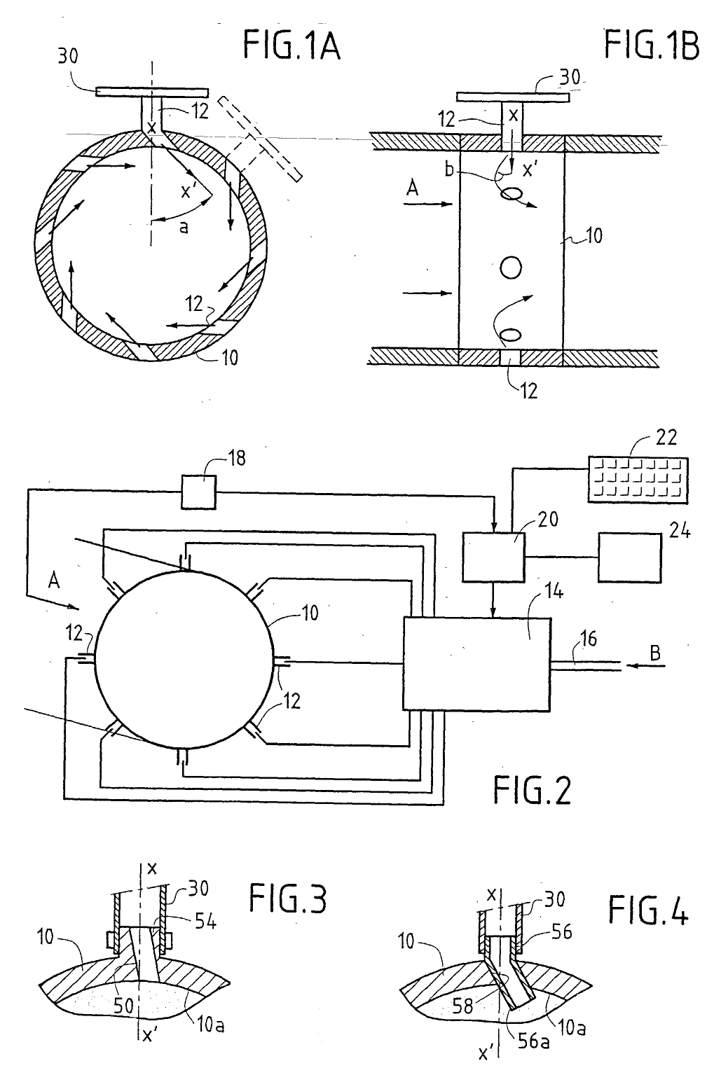

FIG. 1a is a cross-sectional view of a first embodiment of the mixer;

FIG. 1b is a longitudinal sectional view of a mixer of the type illustrated in FIG. 1a;

FIG. 2 shows the mixer assembly, which includes its control means;

FIG. 3 shows a first embodiment of an injector;

FIG. 4 shows a second embodiment of an injector;

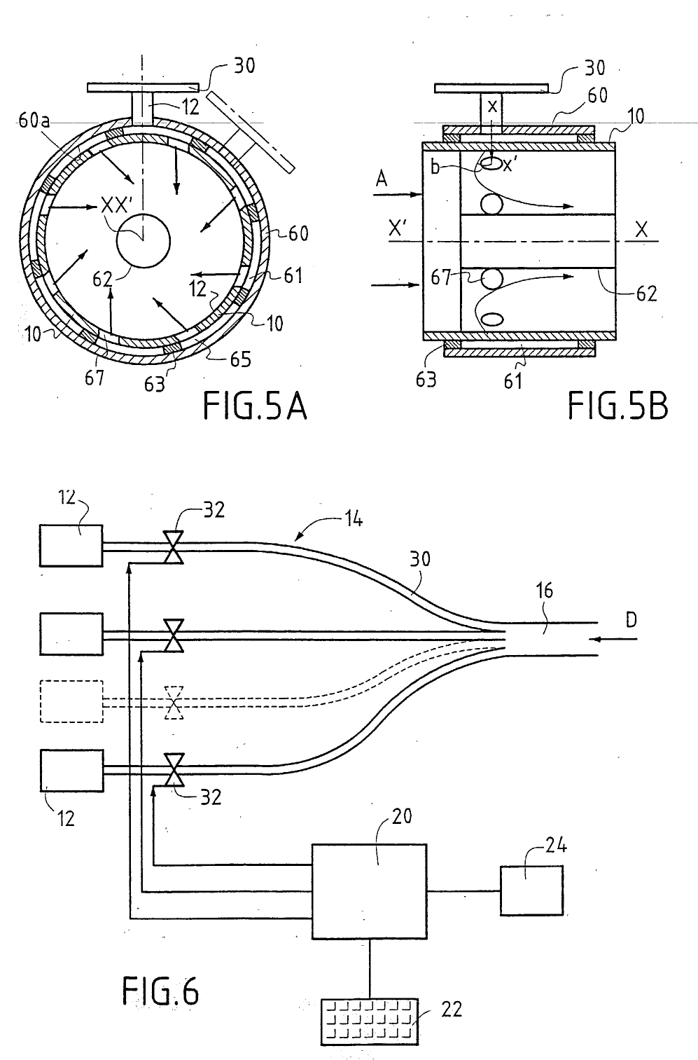

FIG. 5a shows a cross section of a second embodiment of the mixer;

FIG. 5b shows a longitudinal section of a mixer of the type illustrated in FIG. 5a;

FIG. 6 shows a first embodiment of the control system for the mixer;

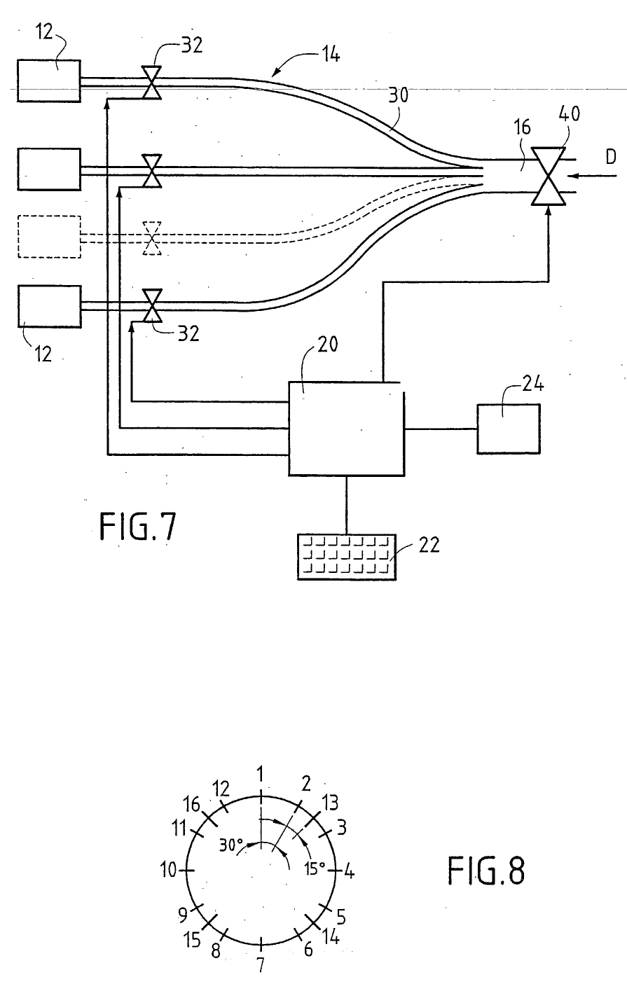

FIG. 7 shows a second embodiment of the control system for the mixer; and

FIG. 8 is a schematic view illustrating a preferred way of controlling the various injectors.

Referring firstly to FIGS. 1 and 2, a first embodiment of the mixer and the method used by this mixer will be described.

FIGS. 1a and 1b show a cylindrical pipe 10 through which the flow of primary gas A travels. The pipe 10 defines a mixing length or mixing zone L. Injectors such as 12, which will be described in greater detail later, emerge in the internal wall 10a of the pipe. According to this embodiment, the injectors are all placed in the same cross section of the pipe. In other embodiments, the injectors could be staggered along the axis of the pipe, while still remaining within an injection zone whose length is very much shorter than the mixing length. The mixing length may be equal to 2, 3 or 4 times the diameter of the pipe. In this embodiment, the injectors 12 are placed uniformly around the internal periphery of the pipe. According to one characteristic of this embodiment, the axes x, x′ of the injectors make, in projection on a cross-sectional plane of the pipe 10, an angle a with the normal N to the internal wall of the pipe. The angle a lies between 10 and 70 degrees and preferably between 25 and 45 degrees. These injectors, as will be explained later, serve for feeding the pipe with the secondary gas. It will be understood that when the axes of the injectors have the angulation a, the secondary-gas jets induce a swirling motion which encourages mixing of the secondary gas with the flow of primary gas A.

Furthermore, the direction of the axis xx′ of each jet is either contained in the traverse plane of the pipe containing the outlet orifices of the injectors or is directed towards the upstream end of the pipe with respect to this plane, making an angle b with the latter (see FIG. 1B) so as to reduce the mixing length.

Represented in FIG. 2 is the portion of pipe 10 in which the stream of primary gas A flows as well as, schematically, the injectors 12. This figure also shows a valve unit 14, this valve unit 14, as will be explained later, consisting of valves which can be automatically or manually controlled so as to interrupt the gas feed to one of the injectors 12 or to feed gas to some or all of the injectors with a defined flow rate. This figure shows schematically the main pipe 16 for feeding the secondary gas B, the secondary gas being distributed to each injector via the unit 14. Also shown in an automated version of the mixer is a flow rate sensor 18, for measuring the flow rate of primary gas in the pipe 10, as well as a control unit 20 for the valve device 14. The control unit 20 is also linked to a data input interface 22, for example a keyboard, making it possible in particular to enter a percentage of secondary gas in the final mixture into the unit 20. The control unit 20 is linked to a memory 24 which in particular stores control tables indicating the injectors to be fed in order to obtain a given percentage of secondary gas as well as the flow rate which must be applied to the injectors fed. The circuits of the control unit 20, based on the secondary-gas percentage information and the primary-gas flow rate information, compute the secondary-gas flow rate and determine, from the tables contained in the memory 24, the injectors which must be fed via the valve device 14, as well as the common flow rate that each of the injectors fed must receive.

The total secondary-gas flow rate may also be controlled based on a setpoint value which may not be the percentage of secondary gas in the primary gas. This setpoint may, for example, be calculated from a measurement made on operations carried out downstream of the mixer. In this case, the ratio of the mixture produced by the mixer is not fixed but depends on a measurement made downstream of the mixer.

Referring now to FIG. 6, a first embodiment of the valve unit 14 will be described. This figure shows the line 16 for supplying the secondary gas, as well as the various injectors 12. The supply line 16 splits up into as many individual feed pipes 30 as there are injectors 12. Mounted on each pipe 30 is a controllable valve 32. In an automated version, the valves are controlled by the control unit 20, as explained above. The valves 32 are controlled so as to be fully open or closed, or to have an intermediate opening corresponding to a flow rate within the optimum flow rate range of the injector. This optimum flow rate depends on the characteristics of the injector, on the dimensions of the pipe and on the primary gas flow rate so as to obtain the optimum energy for the jet produced by the injector. In other words, either the valve 32 is closed or the valve 32 is set so as to give the flow rate corresponding to the percentage of secondary gas to be injected. In addition, all the open valves are set to give the corresponding injectors 12 the same feed flow rate.

FIG. 7 shows a second embodiment of the valve unit 14. The latter comprises a master regulating valve 40 on the main secondary-gas feed pipe 16 The individual lines 30 are all equipped with an on/off control valve 32. The control unit 20 controls the on/off valves (32), as already indicated. Furthermore, this unit controls the master valve 40 in such a way that it delivers secondary gas with the total flow rate D. This flow rate is distributed into the various lines 30 associated with the open individual valves 32.

FIGS. 3 and 4 show two embodiments of the injectors. According to the embodiment in FIG. 3, the injector consists of a bore 50 machined into the wall 52 of the pipe 10. This bore is extended by a sleeve 54 for connection to the feed pipe 30. In this case, the opening of the injector emerges in the internal surface 10a of the pipe.

In the case of the embodiment in FIG. 4, the injector consists of a tubular element 56 fitted into a bore 58 of the wall 52 of the pipe 10. In this case, the opening of the injector 56a may project from the internal wall lOa of the pipe 10.

Another embodiment of the injectors consists in providing, inside the pipe 10, a closed toroidal pipe whose wall is drilled with orifices constituting the injectors. The pipe is divided by radial partitions into as many internal volumes as there are injectors.

Each internal volume is fed individually. It is this solution which is shown in FIGS. 1a to 5a.

FIGS. 5a and 5b show a second embodiment of the gas mixer. This uses the third embodiment of the injectors.

In the injection zone, the pipe 10 has a double wall 60 which defines an annular space 61. The feed pipes 30 emerge in the annular space 61. Radial partitions 63 divide the annular space 61 into several injection volumes 65, each volume 65 being fed via a pipe 30. The internal wall 10 is drilled with orifices 67 forming the injectors. Preferably, there is one orifice 67 per volume 65. However, in certain cases it is possible to provide several injectors fed via the same volume 65. This will be the case if two injectors must always deliver the same flow rate.

The injectors 67 may all be placed in the same cross section of the pipe 10. This is the situation shown in FIGS. 5a and 5b. It is also possible to stagger the injectors 67 along the axis XX′ of the pipe 10. The secondary gas is then injected over an injection zone, this injection zone having to have a length which is less than that of the mixing zone, as defined above.

In this embodiment, there is also in the mixing zone L a central obstacle 62, for example of cylindrical overall shape (cylinder, cone, truncated cone, etc.), which is placed along the axis XX′ of the pipe 10. Preferably, the equivalent diameter of the obstacle is between 10 and 30% of that of the pipe 10. The obstacle 62 is supported by a radiating structure 64 which thus forms an element for disturbing the flow of primary gas in the pipe 10. In this case, it is not necessary for the axes of the injectors 12 to be inclined. This is because the presence of an obstacle reduces the risk of the jets coalescing, particularly those jets which are in opposition.

According to the invention, it is possible to optimize the control of the various injectors, so as to make the mixing as homogeneous as possible, if it desired to have a flow rate which varies continuously between 2d1 and Nd2, d1 being the lower flow rate limit of the optimum flow rate range, d2 being the maximum flow rate of this same range and N being the total number of injectors.

The maximum number of injectors to be fed is defined in the following manner:

if D is the total secondary-gas flow rate, D is divided, into a set of integers, by dl, giving a quotient k and a remainder r;

if k≧N, the number of injectors N1 to be fed is equal to N and the flow rate of each injector is D/N;

if k<N, the number N1 of injectors to be fed is equal to k and the flow rate of each injector is equal to D/N.

If it is desired to improve the mixing homogeneity further, for example by requiring the injectors fed to be diametrically opposed in pairs, it is firstly necessary to choose an even N and to stagger the injectors angularly in a uniform fashion (360/N degrees).

The condition that N−N1 be divisible by N1 or that N1 be divisible by N−N1 is added.

N1=k is then chosen if N−k is divisible by k or if k is divisible by N−k.

Otherwise, N1 is chosen to be the number immediately lower than k which satisfies this condition.

The embodiment of the mixer and implementation of the mixing method described above, whatever its embodiment, makes it possible in particular to obtain, continuously, within a wide secondary-gas flow rate range, all the intermediate flow rates, while still ensuring homogeneous mixing of the secondary gas into the primary gas.

The optimum arrangement for homogeneous mixing is, of course, one in which the fed injectors are uniformly distributed angularly for the entire flow rate range. For injectors distributed uniformly angularly, this means that N must be divisible by N1. According to the various operating conditions, such a condition can be fulfilled only for one secondary-gas flow rate range.

FIG. 8 illustrates an arrangement of the injectors which provides complete symmetry of the injectors fed, whatever the envisaged flow rate. In FIG. 8, the numbers 1 to 16 indicate the positions of the various injectors. The injectors identified by the numbers 1 to 12 are staggered angularly by an angle at the centre of 30 degrees. The injectors numbered 13 to 16 are staggered with respect to one another by an angle at the centre of 90 degrees. In addition, each injector of the second series is equidistant from two injectors of the first series which surround it. One possible embodiment is for the injector 13 to be staggered by 15 degrees with respect to the injector 2, for the injector 14 to be staggered by 15 degrees with respect to the injector 5, for the injector 15 to be staggered by 15 degrees with respect to the injector 8 and finally for the injector 16 to be staggered by 15 degrees with respect to the injector 11.

Table 1 illustrates an application example of the mixer defined above.

Table I shows, for the various flow rate ranges between 160 and 1440 m³/h, the total flow rate delivered by the injectors in the left-hand column, the number of injectors fed in the middle column and the numerical reference of the injectors actually fed and as they are identified in FIG. 8.

TABLE I

| Total flow rate | Active orifices N1 | No. of the active orifices |
|---|---|---|
| 160-240 | 2 | 1, 7 |
| 240-360 | 3 | 1, 5, 9 |
| 320-480 | 4 | 1, 4, 7, 10 |
| 480-720 | 6 | 1, 3, 5, 7, 9, 11 |
| 640-960 | 8 | 1, 13, 4, 14, 7, 15, 10, 16 |
| 960-1440 | 12 | 1 to 12 |

Thus, it may be seen that the secondary-gas flow rate can be varied continuously between 160 m³/h and 1440 m³/h, while still ensuring that each injector is fed in its optimum operating range, that is to say in the case in question between 80 m³/h and 120 m³/h.

It will be understood that in this case the memory 24 associated with the unit 20 for controlling the valves contains Table I. When the percentage of secondary gas to be injected is entered using the interface device 22, the unit 20, based on the primary-gas flow rate information, determines the total secondary-gas flow rate needed and, depending on the position of this flow rate with respect to the various ranges in Table I, determines which valves have to be opened and the individual flow rate in each of these valves.

The embodiment illustrated in FIG. 8 corresponds to an optimum embodiment which, as already indicated, allows a nominal secondary-gas flow rate that can vary continuously by a factor of 1 to 6. It goes without saying that, if the secondary-gas flow rates do not need to vary continuously but only around discrete values, it is possible, of course, to reduce the number of injectors. However, in this case, the feed mode of the injectors is always the same, that is to say either one injector is not fed, or it is fed with gas having a flow rate lying within its optimum operating range. It will be understood that by virtue of these arrangements homogeneous mixing of the secondary gas into the primary gas is effectively obtained because, on the one hand, the injectors are uniformly distributed around the periphery of the pipe of the mixer and, on the other hand, each injector operates within its optimum operating range.

In the illustrative example of the method described above, all the injectors have the same optimum flow rate range. In some circumstances, this might not be the case. This could occur if all the injectors do not have the same dimensions. This will also occur if the characteristics of the gas delivered by the injectors are not the same. These differences may stem from the nature of the gas injected, which may not be the same for all the injectors. They may stem from the temperature or pressure characteristics of the gas injected, if this gas is delivered from various sources.

1. Method for mixing a secondary gas with a primary gas, by means of injectors, comprising the following steps:
a primary stream of the said primary gas is formed;
the total flow rate of secondary gas to be injected is regulated according to a setpoint value;
the secondary gas is injected with the said total flow rate into an injection zone of the said primary stream, the said injection zone extending in the direction of the axis of the said primary stream, by means of a plurality of injectors placed in the said injection zone so as to form a plurality of secondary-gas jets, each injector having an optimum flow rate range; and
the said secondary gas is distributed between at least some of the said injectors in such a way that each injector fed operates within its optimum flow rate range.

2. Method according to claim 1, characterized in that each injector has the same optimum flow rate range.

3. Method according to either of claims 1 and 2, characterized in that the said injectors are all placed approximately in the same plane orthogonal to the axis of the said primary stream.

4. Method according to any one of claims 1 to 3, characterized in that the axis of at least some of the injectors (12) makes, in the cross section of the stream of primary gas which contains the openings of the injectors, an angle a lying between 10 and 70 degrees with the normal to the wall of the pipe.

5. Method according to claim 4, characterized in that the said angle a lies between 25 and 45 degrees.

6. Method according to claim 1, characterized in that, in addition, an obstacle is placed in the mixing zone of the said stream of primary gas, along the longitudinal axis of the said stream.

7. Method according to claim 6, characterized in that a disturbance of the stream of primary gas is created in the zone containing the said obstacle.

8. Method according to any one of claims 1 to 7, in order to be able to mix into the primary gas a secondary gas with a flow rate D lying between 2d₁, d₁ being the minimum value of the optimum flow rate range of the injectors, and Nd₂, d₂ being the maximum value of the optimum flow rate range of the injectors, characterized in that the maximum number N1 of injectors to be fed is determined in the following manner:
the flow rate D is divided, into a set of integers, by d₁, which gives an integer quotient k and a remainder r;
the quotient k is compared with the number N of injectors and
if k≧N, then N1=N or
if k<N, then N1=k
and in that the flow rate of each of the N1 injectors is equal to D/N1.

9. Method according to claim 8, in which the N injectors are uniformly distributed angularly, characterized in that, in order to determine the number N1 of injectors fed, the condition that N−N1 be divisible by N1 or that N1 be divisible by N−N1 is added, in such a way that the injectors fed are opposed in pairs;
and the number k is chosen for N1 if N−k is divisible by k or if k is divisible by N−k;
otherwise, N1 is chosen to be the integer immediately lower than k which satisfies this condition.

10. Method according to claim 8, characterized in that the injectors are uniformly distributed angularly and in that N1 is chosen in such a way that N is divisible by N1.

11. Method according to claim 8, characterized in that the number of injectors N is chosen to be equal to 16 and in that 12 of the 16 injectors are distributed uniformly with an angular separation equal to 30 degrees and in that the other 4 injectors are distributed at 90 degrees with respect to one another in such a way that each of the four injectors is at an equal angular distance from two of the twelve first injectors, whereby the injectors fed are uniformly distributed angularly.

12. Mixer for mixing a secondary gas into a primary gas, which comprises:
a pipe (10) for supplying the primary gas, the said pipe having an injection zone;
N (N≧2) secondary-gas injectors (12), the openings of which run into the injection zone of the said pipe, each injector having an optimum flow rate range; and
means for distributing the total secondary-gas flow rate between at least some of the said injectors so that each injector is fed with gas at a zero flow rate or at a flow rate lying within the optimum flow rate range of the said injector.

13. Mixer according to claim 12, characterized in that all the injectors have their openings running approximately into the same cross section of the pipe.

14. Mixer according to either of claims 12 and 13, characterized in that all the injectors have the same optimum flow rate range.

15. Mixer according to any one of claims 12 to 14, characterized in that the distributing means comprise:
valve-based means (14) for controlling the secondary-gas flow rate in the said injectors;
control means (20) for controlling the said valve-based means (14) so that each injector is fed with gas at a zero flow rate or at a flow rate common to all the injectors fed, the said common flow rate lying within the optimum flow rate range.

16. Mixer according to any one of claims 12 to 15, characterized in that the axis of at least some of the injectors (12) makes, in the cross section of the pipe which contains the openings of the injectors, an angle a lying between 10 and 70 degrees with the normal to the wall of the pipe.

17. Mixer according to claim 16, characterized in that the said angle a lies between 25 and 45 degrees.

18. Mixer according to any one of the claims 12 to 15, characterized in that it furthermore includes an obstacle (62) placed in the mixing zone of the said pipe (10), along the longitudinal axis of the said pipe.

19. Mixer according to claim 18, characterized in that it furthermore includes means (64) for fastening the said obstacle (62) to the pipe, these being suitable for creating a disturbance in the flow of primary gas.

20. Mixer according to either of claims 18 and 19, characterized in that the axes of the injectors (12) are approximately normal to the wall in the cross-sectional plane that contains the openings of the injectors.

21. Mixer according to any one of claims 16 to 20, characterized in that the axes of the injectors (12) are in the cross-sectional plane containing the openings of the injectors or are directed towards the upstream end of the said pipe with respect to the said plane.

22. Mixer according to claim 15, characterized in that the said valve-based means (14) comprise N valves (32) which can be controlled so as to be fully open or closed, each valve being associated with an injector and a main valve (40) capable of setting the total flow rate of the said valves to N′ times a flow rate lying within the said optimum flow rate range, N′ being the number of valves not closed.

23. Mixer according to claim 15, characterized in that the said valve-based means (14) comprise N valves (32), each valve being associated with an injector (12), each valve being controllable so as to let gas through with a zero flow rate or with a flow rate lying within the said range.

24. Mixer according to any one of claims 12 to 15, characterized in that it comprises N-1 injectors (12) whose axes make the said angle a with the normal to the wall of the pipe and one injector whose axis is normal to the wall of the pipe.

25. Mixer according to any one of claims 12 to 15, characterized in that the number N of injectors (12) is equal to 16, and in that 12 of the 16 injectors are uniformly distributed angularly around the periphery of the pipe with an angular separation equal to 30 degrees and in that the other four injectors are uniformly distributed angularly with an angular separation equal to 90 degrees in such a way that each of the four injectors is at an equal angular distance from two of the twelve first injectors.
